(19) United States
(12) Patent Application Publication
(10) Pub. No.: US 2023/0393909 A1
(43) Pub. Date: Dec. 7, 2023

(54) AUTOMATICALLY MANAGING EVENT-RELATED COMMUNICATION DATA USING MACHINE LEARNING TECHNIQUES

(71) Applicant: Dell Products L.P., Round Rock, TX (US)

(72) Inventors: Bijan Kumar Mohanty, Austin, TX (US); Harish Mysore Jayaram, Cedar Park, TX (US); Barun Pandey, Bangalore (IN); Hung T. Dinh, Austin, TX (US)

(21) Appl. No.: 17/834,294

(22) Filed: Jun. 7, 2022

(51) Int. Cl. G06F 9/54; G06N 3/08; H04L 9/40

(52) U.S. Cl. CPC G06F 9/542; G06N 3/08; H04L 63/0428

(57) ABSTRACT

Methods, apparatus, and processor-readable storage media for automatically managing event-related communication data using machine learning techniques are provided herein. An example computer-implemented method includes obtaining event-related communication data generated in connection with one or more systems associated with at least one enterprise; comparing identifying information pertaining to one or more event notifications within the event-related communication data to identifying information pertaining to multiple historical event notifications; predicting, for the one or more event notifications upon determining that the identifying information pertaining to the one or more event notifications differs from the identifying information pertaining to the multiple historical event notifications, at least one communication channel and at least one communication format by processing at least a portion of the event-related communication data using machine learning techniques; and performing one or more automated actions based on the at least one predicted communication channel and the at least one predicted communication format.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to techniques for processing data using such systems.

### BACKGROUND

Enterprises use various communication mechanisms to convey the progress of certain processes. For example, an enterprise can use event notifications from different systems for multiple types of engagements in connection with a given item lifecycle. Typically, particular actions are triggered as events at the beginning or completion of a process, and notifications of such events are intended to inform one or more users or other systems of the progress of the given workflow. Event notifications can vary in terms of channels (e.g., email, short message service (SMS), push notifications, etc.) as well as format of communication. However, conventional event notification systems are commonly stateless in nature, which results in redundant communications that adversely impact user experience. Also, conventional event notification systems lack capabilities for determining and/or managing the channel(s) and messaging format(s) of the communications based on the context of the event(s), further adversely impacting user experience.

### SUMMARY

Illustrative embodiments of the disclosure provide methods for automatically managing event-related communication data using machine learning techniques. An exemplary computer-implemented method includes obtaining event-related communication data generated in connection with one or more systems associated with at least one enterprise, and comparing identifying information pertaining to one or more event notifications within the event-related communication data to identifying information pertaining to multiple historical event notifications. Also, the method includes predicting, for the one or more event notifications upon determining that the identifying information pertaining to the one or more event notifications differs from the identifying information pertaining to the multiple historical event notifications, at least one communication channel and at least one communication format by processing at least a portion of the event-related communication data using machine learning techniques. Further, the method includes performing one or more automated actions based on the at least one predicted communication channel and the at least one predicted communication format.

Illustrative embodiments can provide significant advantages relative to conventional event notification systems. For example, problems associated with redundant communications and lack of context-based determinations are overcome in one or more embodiments through automatically managing event-related communication data and related information using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically managing event-related communication data using machine learning techniques in an illustrative embodiment.

FIG. 2 shows example system architecture in an illustrative embodiment.

FIG. 3 shows example architecture of a machine learning-based event communication channel and format prediction engine in an illustrative embodiment.

FIG. 4 shows example neural network architecture in an illustrative embodiment.

FIG. 5 shows example pseudocode for data preprocessing in an illustrative embodiment.

FIG. 6 shows example pseudocode for converting categorical values to encoded values in an illustrative embodiment.

FIG. 7 shows example pseudocode for splitting a dataset for training and testing in an illustrative embodiment.

FIG. 8 shows example pseudocode for neural network model creation in an illustrative embodiment.

FIG. 9 shows example pseudocode for model training, validation, and execution in an illustrative embodiment.

FIG. 10 shows example pseudocode for implementing at least a portion of an event notification hashing engine in an illustrative embodiment.

FIG. 11 is a flow diagram of a process for automatically managing event-related communication data using machine learning techniques in an illustrative embodiment.

FIGS. 12 and 13 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

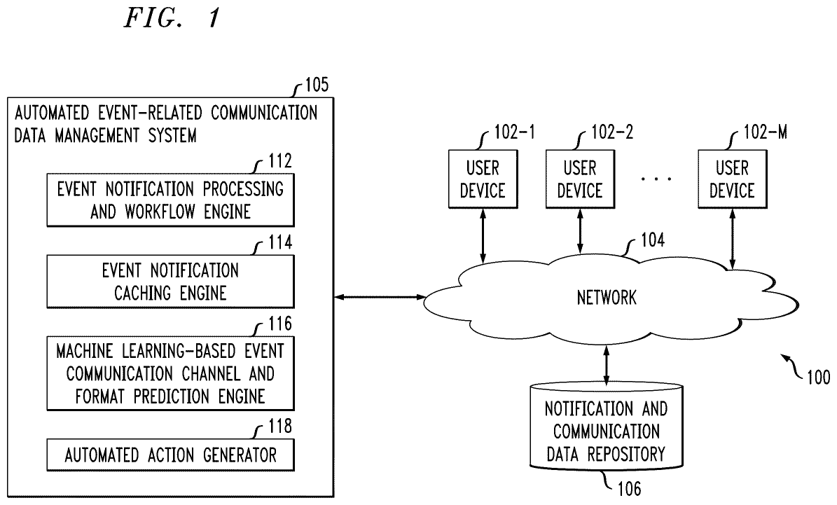

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated event-related communication data management system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated event-related communication data management system 105 can have an associated notification and communication data repository 106 configured to store data pertaining to event-related messages and/or accompanying information, which comprise, for example, subject matter information, channel information, format information, participant information, etc.

The notification and communication data repository 106 in the present embodiment is implemented using one or more storage systems associated with automated event-related communication data management system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated event-related communication data management system 105 are one or more input-output devices, which illustratively comprise keyboards, displays or other types of input-output devices in any combination. Such input-output devices can be used, for example, to support one or more user interfaces to automated event-related communication data management system 105, as well as to support communication between automated event-related communication data management system 105 and other related systems and devices not explicitly shown.

Additionally, automated event-related communication data management system 105 in the FIG. 1 embodiment is assumed to be implemented using at least one processing device. Each such processing device generally comprises at least one processor and an associated memory, and implements one or more functional modules for controlling certain features of automated event-related communication data management system 105.

More particularly, automated event-related communication data management system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated event-related communication data management system 105 to communicate over the network 104 with the user devices 102, and illustratively comprises one or more conventional transceivers.

The automated event-related communication data management system 105 further comprises event notification processing and workflow engine 112, event notification caching engine 114, machine learning-based event communication channel and format prediction engine 116, and automated action generator 118.

It is to be appreciated that this particular arrangement of elements 112, 114, 116 and 118 illustrated in the automated event-related communication data management system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for automatically managing event-related communication data using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated event-related communication data management system 105 and notification and communication data repository 106 can be on and/or part of the same processing platform.

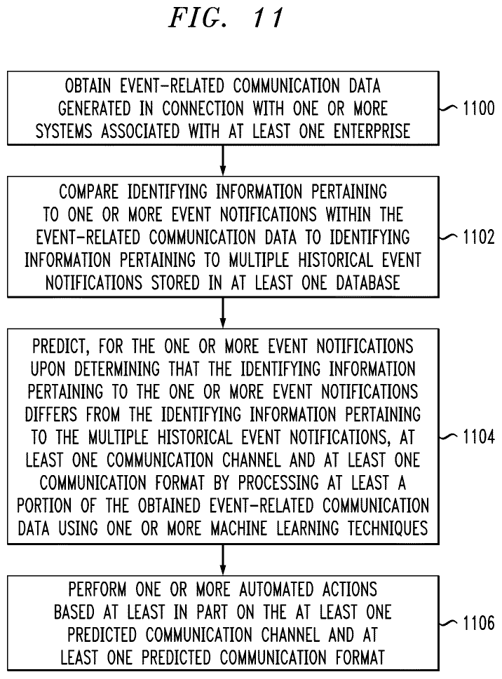

An exemplary process utilizing elements 112, 114, 116 and 118 of an example automated event-related communication data management system 105 in computer network 100 will be described in more detail with reference to the flow diagram of FIG. 11.

Accordingly, at least one embodiment includes generating and/or implementing a machine learning-based enterprise event notification and communication framework. Such an embodiment can include processing event notifications from various systems and, by leveraging historical notification data and one or more machine learning techniques, predicting and/or determining the type(s) of channel suited for each such event notification. One or more embodiments also include using historical data and machine learning techniques to recommend one or more specific communication message templates and/or formats applicable for the context of each such event notification. Further, as detailed herein, at least one embodiment includes implementing a notification decision engine, which leverages at least one hashing algorithm, to verify if an event has been previously communicated via a prior notification, thus eliminating redundant notifications for the same event.

Accordingly, one or more embodiments include utilizing historical event notification data with context-related information such as, e.g., channel information, message template information, etc., as training data for one or more machine learning models. Additionally, such machine learning models can be trained to predict appropriate channels and message templates specific to the context of particular event notifications. Also, as noted above and further detailed herein, such an embodiment includes leveraging at least one hash algorithm to hash event data, and implementing at least one smart cache to verify if at least one given event has been previously communicated via a notification to eliminate redundancy.

One or more embodiments include conducting data engineering steps to obtain historical event notification data and extract therefrom one or more features and/or independent variables such as, for example, event type (e.g., sales, case, project, etc.), product-related information, service-related information, geographic-related information, etc., as well as one or more target variables such as, for example, channel information and message format information. At least a portion of such extracted information can then be filtered to create a dataset that can be stored (e.g., in a historical data repository) for future training of one or more machine learning models and related analysis.

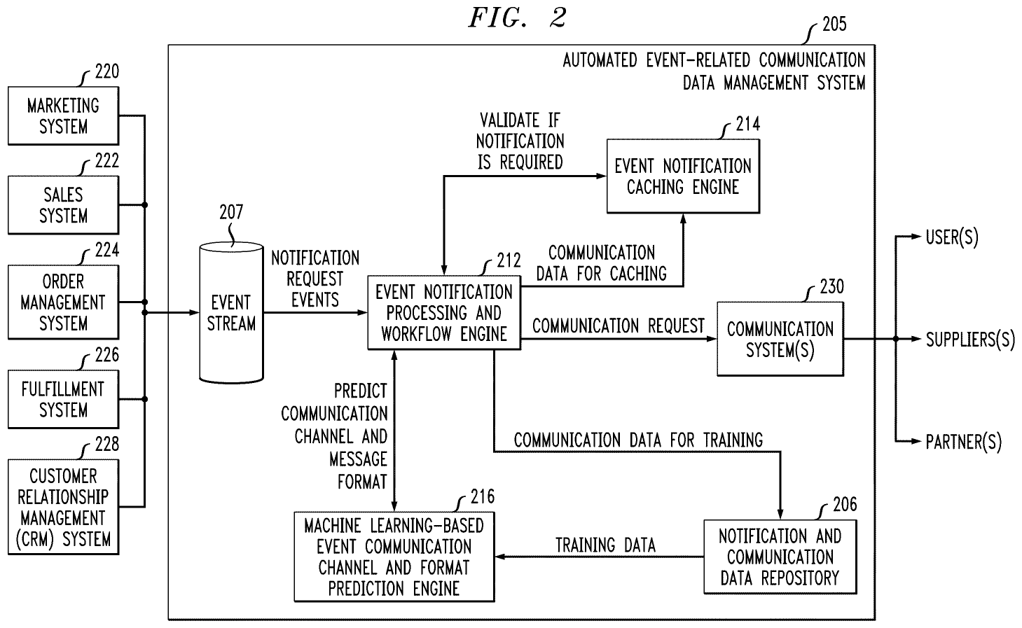

FIG. 2 shows example system architecture of automated event-related communication data management system 205 in an illustrative embodiment. As depicted in FIG. 2, event notification requests can be generated as part of one or more processes in various enterprise systems (e.g., marketing system 220, sales system 222, order management system 224, fulfillment system 226, customer relationship management (CRM) system 228, etc.). For example, in connection with sales system 222 and/or order management system 224, at various stages of one or more process, notification events can be generated for communicating the progress of the given workflow(s). Similarly, in connection with fulfillment system 226 and/or CRM system 228, events can be generated as processes reach certain stages. Such events are passed through an event stream component 207 for processing by the event notification processing and workflow engine 212. As multiple requests for the same event can potentially be generated by one or more of the enterprise systems, the event notification processing and workflow engine 212 leverages the event notification caching engine 214 to determine and/or validate whether a given event has been communicated earlier in connection with a previous notification.

If a new communication for a given event request is required, the event notification processing and workflow engine 212 leverages the machine learning-based event communication channel and format prediction engine 216 to predict the channel type and message format of the communication. Such a prediction is based at least in part on historical event notification and communication data, such as stored in the notification and communication data repository 206. Once channel information and message format information are determined and/or selected, the machine learning-based event communication channel and format prediction engine 216 will send, via the event notification processing and workflow engine 212, relevant details (e.g., channel information, message information, destination information, etc.) to the notification communication system(s) 230 for building the message(s) and sending the communication in the selected channel. Once successfully sent (e.g., to at least one user, at least one supplier, at least one enterprise partner, etc.), these notification and communication transactions are stored in the notification and communication data repository (e.g., for future model training) as well as to the event notification caching engine (e.g., for future query validation).

As detailed above and further described herein in connection with one or more embodiments, a notification and communication data repository can contain historical event notification and/or communication data from various enterprise systems (e.g., sales systems, order management systems, fulfillment systems, supply chain systems, support systems, etc.) that trigger events for notifications. Data engineering and data preprocessing actions are carried out to identify and/or learn one or more data features and/or data elements that may influence the predictions for channel and message format. By way merely of example, data features and/or data elements that might influence such predictions can include notification event source and/or application (e.g., sales, support, manufacturing, etc.), event type (e.g., order booking, case, incident, etc.), event status (e.g., complete, unsuccessful, etc.), destination (e.g., person, system, application, etc.), external versus internal, geographic region, language, etc.

In at least one embodiment, such an analysis can include using multivariate-variate plots and correlation heat maps to identify the significance of each of one or more features in a dataset such that less important data elements (e.g., data elements determined to be below a predetermined value of influence) are filtered out. In determining how influential a given data element is, one or more embodiments can include carrying out one or more steps as part of feature selection in connection with a machine learning process. For example, feature correlation can be computed using a correlation heat map of the dataset in question (e.g., implementing a Seaborn plotting library to create a correlation heat map), wherein such a correlation heat map will show multiple features and the target variables in a heat map, with each feature's correlation and importance relative to the target variables and the other features. In at least one embodiment, two feature values that are highly correlated are typically redundant, and as such, one of the two features can be filtered out (e.g., deleted). Such filtering reduces the dimension and complexity of the dataset and/or corresponding model, thereby improving accuracy and performance.

As also noted above and further detailed herein, a machine learning-based event communication channel and format prediction engine enables event message communication with intelligence automation. A machine learning-based event communication channel and format prediction engine leverages at least one supervised learning mechanism and at least one multi-output prediction method to determine and/or predict both channel and message format in connection with a given event notification and/or communication. In one or more embodiments, the machine learning techniques implemented in connection with this engine are trained using the same data attributes and/or features for both target variables (i.e., communication channel and communication format).

The data attributes and/or features that influence the target variables and are extracted from the dataset can include, for example, event type information, work order information, project information, sales information, status information (e.g., process stage), destination information (e.g., customer, partner, supplier, etc.), geographic region information, language information, etc. During the training, such features are processed by the machine learning techniques as the independent variables, and the actual value of the output (i.e., channel and format) are processed as the dependent/target values. Accordingly, by way merely of example, upon receiving a new event request, a trained multi-output classifier-based model (as part of the machine learning-based event communication channel and format prediction engine) is used to predict the channel and format of the communication.

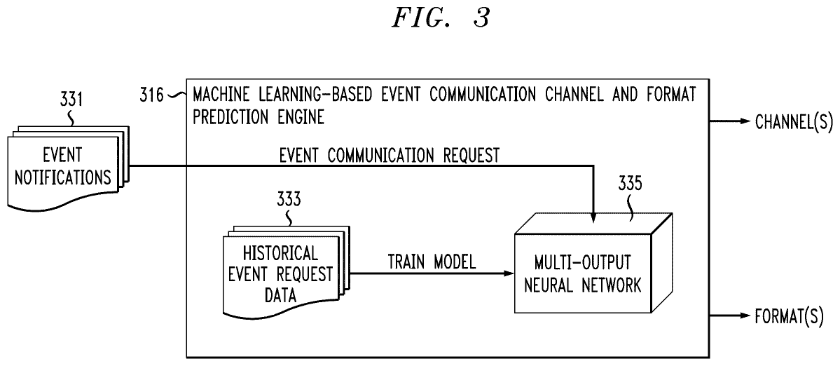

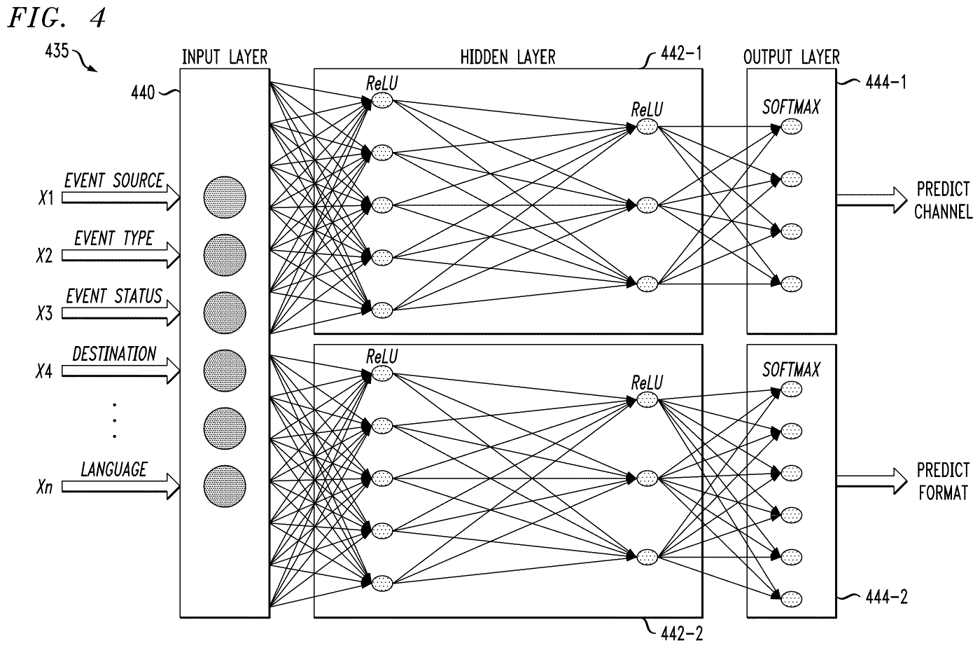

FIG. 3 shows example architecture of machine learning-based event communication channel and format prediction engine 316 in an illustrative embodiment. As depicted in FIG. 3, the machine learning-based event communication channel and format prediction engine 316 utilizes a multi-output neural network 335, a deep neural network that has multiple parallel branches of the network for two types of outputs (e.g., such as further detailed in connection with FIG. 4). By taking the same set of input variables as a single input layer and building a dense, multi-layer neural network, the machine learning-based event communication channel and format prediction engine 316 acts as a classifier for multi-output predictions.

In one or more embodiments, the multi-output neural network 335 includes an input layer, one or more (e.g., two) hidden layers, and an output layer. As a multi-output neural network, the neural network creates two separate branches of the network (e.g., within the hidden layer(s) and the output layer) that connects to the same input layer. The input layer can include a number of neurons that matches the number of input and/or independent variables, and in one or more embodiments, the hidden layer(s) includes two layers, while the neuron on each layer depends upon the number of neurons in the input layer. Also, in such an embodiment, the output layer for each branch contains multiple neurons (e.g., matching the classes of the prediction). As depicted in FIG. 3, the multi-output neural network 335 can be trained using historical event request data 333 to process data from event notifications 331 and output one or more predicted channels and one or more predicted communication formats in connection with one or more event notifications.

For example, and as further detailed below in connection with FIG. 4, in a channel branch network, there can be four neurons for four types of channels (e.g., email, SMS, push notification, etc.). Similarly, the number of neurons in the output layer of a format branch network will match the number of formats of communication. While the neurons in the hidden layers, in one or more embodiments, use a rectified linear unit (ReLU) activation function, the neurons in the output layer can utilize a softmax activation function (e.g., because of its nature of being a multi-class classifier model for each branch of network).

FIG. 4 shows example neural network 435 architecture in an illustrative embodiment. As depicted in FIG. 4, although there are five neurons/nodes shown in the first hidden layer of layer 442-1 and layer 442-2, and three neurons/nodes shown in the second hidden layer of layer 442-1 and layer 442-2, the actual values can vary and can depend at least in part on the total number of neurons in input layer 440 (e.g., neurons associated with various input data such as data pertaining to event source (X1), event type (X2), event status (X3), destination (X4), language (Xn), etc.). The values in the first hidden layer can be calculated, for example, based on an algorithm of matching the power of two to the number of input nodes. For example, if the number of input variables is 19, it falls in the range of 2⁵, meaning the first layer in such an instance will have 2⁵=32 neurons. In such an example, the second layer will contain 2⁴=16 neurons, and if there is to be a third layer, that third layer should contain of 2³=8 neurons. In at least one embodiment, the neurons in the hidden layers (e.g., 442-1 and 442-2) and the output layer(s) (e.g., output layer 444-1 and output layer 444-2) contain an activation function which determines whether the neuron will fire or not. In a neural network architecture such as depicted in FIG. 4, one or more activation functions (e.g., a ReLU activation function, a softmax activation function) can be used in both of the hidden layers (e.g., layer 442-1 and layer 442-2). Also, considering the model is configured to behave as a multi-class classifier, the output neurons (e.g., in output layer 444-1 and output layer 444-2) can contain one or more activation functions (e.g., a ReLU activation function, a softmax activation function).

As depicted in FIG. 4, one or more embodiments include implementing a dense neural network, wherein each node connects with each other node. In such an embodiment, each connection will have a weight factor and the nodes will have one or more bias factors. These weight and bias factor values can be, for example, set randomly by the neural network 435 (e.g., initially set to 1 or 0 for all values). Each neuron/node performs a linear calculation by combining the multiplication of each input variable (e.g., x1, x2, etc.) with their weight factors, and then adding the bias factor value of the neuron/node.

By way merely of example, a formula for such a calculation can include the following: ws1=x1.w1+x2.w2+ . . . +b1, wherein ws1 represents the weighted sum of node1, x1, x2, etc. represent the input values to the model, w1, w2, etc. represent the weight values applied to the connections to node1, and b1 represents the bias value of node1. In at least one embodiment, this weighted sum is input to an activation function (e.g., ReLU) to compute the value of the activation function. Similarly, weighted sum and activation function values of all other nodes/neurons in the layer are calculated, and these values are fed to the nodes/neurons of the next layer.

In one or more embodiments, the same process can be repeated in the next layer of nodes/neurons until the values are fed to the node/neuron of the output layer(s) (e.g., output layer 444-1 and output layer 444-2). At the output layer(s), the weighted sum is also calculated and compared to the actual target value, and depending upon the difference, a loss value is calculated. Such a pass-through of the neural network is a forward propagation which calculates the error and drives a backpropagation through the neural network to minimize the loss or error at each node/neuron of the network. Considering that the error or loss is generated by all of the nodes/neurons in the network, backpropagation goes through each layer (from back to front) and attempts to minimize the loss or error by using at least one gradient descent-based optimization mechanism.

As the neural network 435 implemented in one or more embodiments is a multi-class classifier, such an embodiment can include using categorical cross entropy as a loss function, adaptive moment estimation (ADAM) and/or root mean squared propagation (RMSProp) as an optimization algorithm, and accuracy as a metric. In at least one embodiment, the same processes can be applied to multiple branches (e.g., a channel branch depicted via hidden layer(s) 442-1 and output layer(s) 444-1, and a format branch depicted via hidden layer(s) 442-2 and output layer(s) 444-2) of neural network 435 in such a multi-output prediction model. Although both branches can be uniform (i.e., have the same number of hidden layers and the same number of neurons in each hidden layer) in one or more embodiments, alternate embodiments can encompass differences across the branches. For example, one branch can be used for classification while another branch can be used for regression. In this type of situation, the neural network architecture will change with respect to the hidden layers and output layer, as well as the activation function(s).

As noted above, a result of backpropagation includes adjusting the weight values and bias values at each connection and node/neuron level to reduce the error/loss. In at least one embodiment, once all observations of the training data are passed through the neural network, an epoch (e.g., epoch1) is completed. Another forward propagation is then initiated with the adjusted weight values and adjusted bias values, which are considered as part of a second epoch (e.g., epoch2), and the same process of forward and backpropagation is repeated in the subsequent epoch(s). This process of repeating across epochs attempts to result in the reduction of loss to a small number (e.g., close to zero), at which point the neural network is considered to be sufficiently trained for generating predictions.

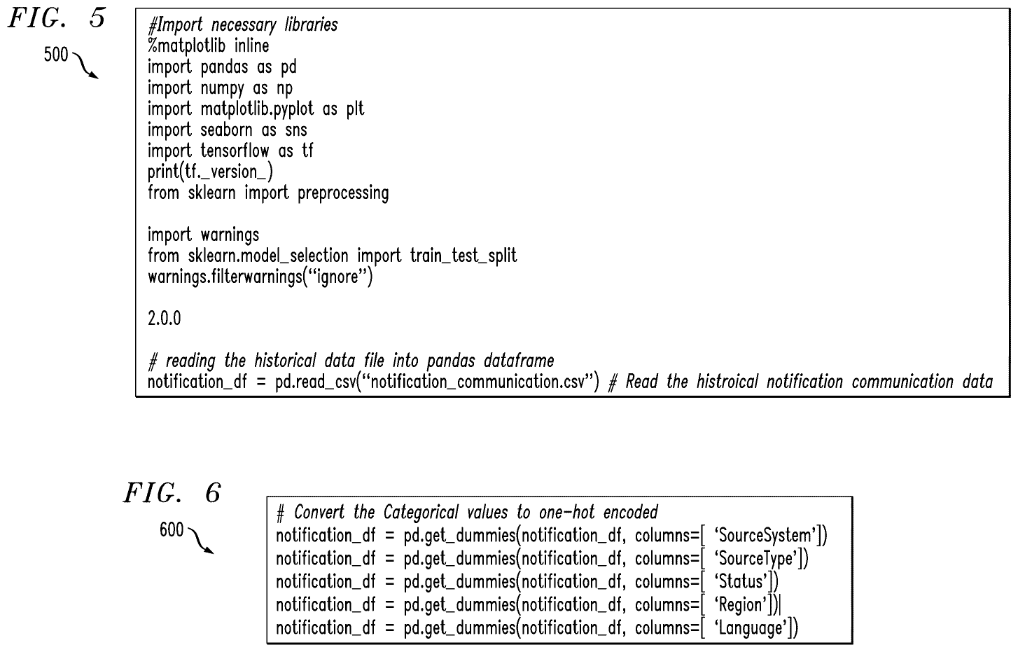

By way of further illustration, implementation of one or more components detailed above and herein are shown in example pseudocode, using Keras with Tensorflow backend, Python language, Pandas, Numpy and ScikitLearn libraries, in FIG. 5 through FIG. 10.

FIG. 5 shows example pseudocode for data preprocessing in an illustrative embodiment. In this embodiment, example pseudocode 500 is executed by or under the control of at least one processing system and/or device. For example, the example pseudocode 500 may be viewed as comprising a portion of a software implementation of at least part of automated event-related communication data management system 105 of the FIG. 1 embodiment.

The example pseudocode 500 illustrates reading the dataset of given notification request and communication data from an historical notification communication repository, and generating a Pandas data frame. This data frame contains columns including independent variables and both dependent/target variable columns (i.e., channel and format). An initial step includes conducting preprocessing of at least a portion of the data to process any null and/or missing values in the columns. Null and/or missing values in numerical columns can be replaced, for example, by the median value of that column. After carrying out the initial data analysis by creating one or more univariate and/or bivariate plots of these columns, the importance and influence of each columns can be learned and/or determined. Columns that have no role or influence on the actual prediction (i.e., target variable) can be dropped.

It is to be appreciated that this particular example pseudocode shows just one example implementation of data preprocessing, and alternative implementations of the process can be used in other embodiments.

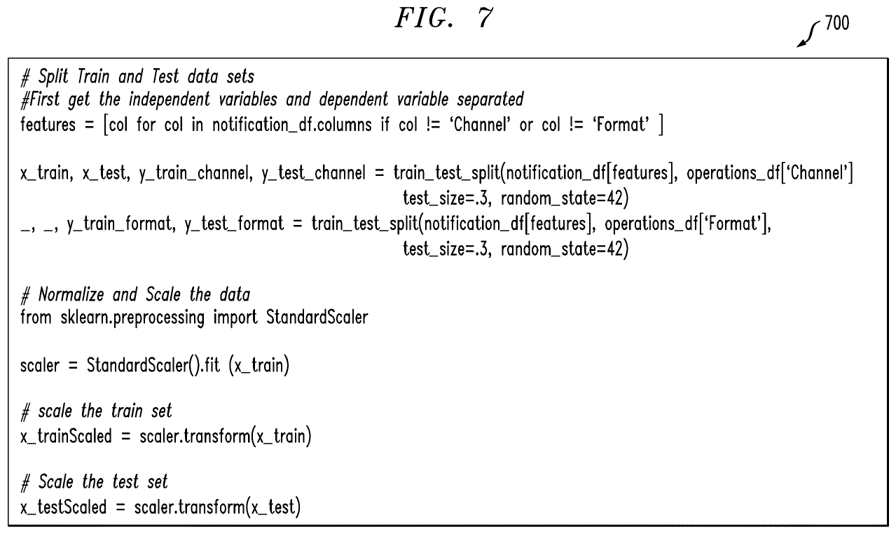

FIG. 6 shows example pseudocode for converting categorical values to encoded values in an illustrative embodiment. In this embodiment, example pseudocode 600 is executed by or under the control of at least one processing system and/or device. For example, the example pseudocode 600 may be viewed as comprising a portion of a software implementation of at least part of automated event-related communication data management system 105 of the FIG. 1 embodiment.

In connection with example pseudocode 600, because the machine learning techniques used in one or more embodiments process numerical values, textual categorical values in the columns must be encoded. For example, an event data source (such as a CRM system, sales system, etc.) and/or event types (such as case information, incident information, etc.) must be encoded. As depicted in FIG. 6, such encoding can be achieved by using one-hot encoding and/or dummy variable encoding (e.g., via a get dummies function of Pandas).

It is to be appreciated that this particular example pseudocode shows just one example implementation of converting categorical values to encoded values, and alternative implementations of the process can be used in other embodiments.

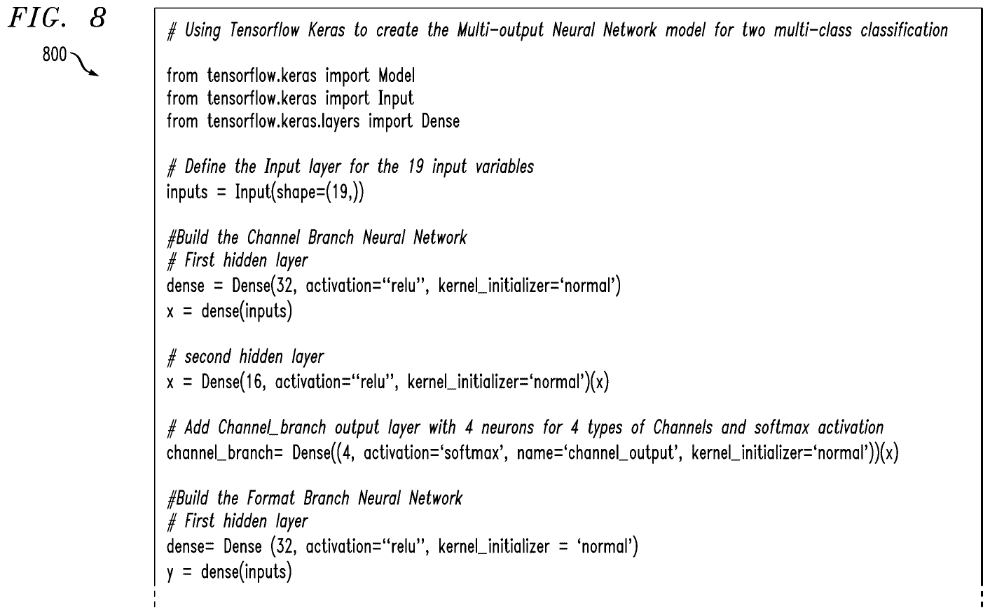

FIG. 7 shows example pseudocode for splitting a dataset for training and testing in an illustrative embodiment. In this embodiment, example pseudocode 700 is executed by or under the control of at least one processing system and/or device. For example, the example pseudocode 700 may be viewed as comprising a portion of a software implementation of at least part of automated event-related communication data management system 105 of the FIG. 1 embodiment.

The example pseudocode 700 illustrates splitting a dataset into training and testing datasets using a train_test_split function of a ScikitLearn library (e.g., with 70% training data to 30% testing data split). In one or more embodiments, which include a multi-class classification use case and a dense neural network, scaling data (before passing data to the model) is performed after the training and testing split is carried out. This can be achieved, for example, by passing the training data and the test data to a StandardScaler of a ScikitLearn library. At the end of such activities, the data can be deemed ready for model training and/or testing.

It is to be appreciated that this particular example pseudocode shows just one example implementation of splitting a dataset for training and testing, and alternative implementations of the process can be used in other embodiments.

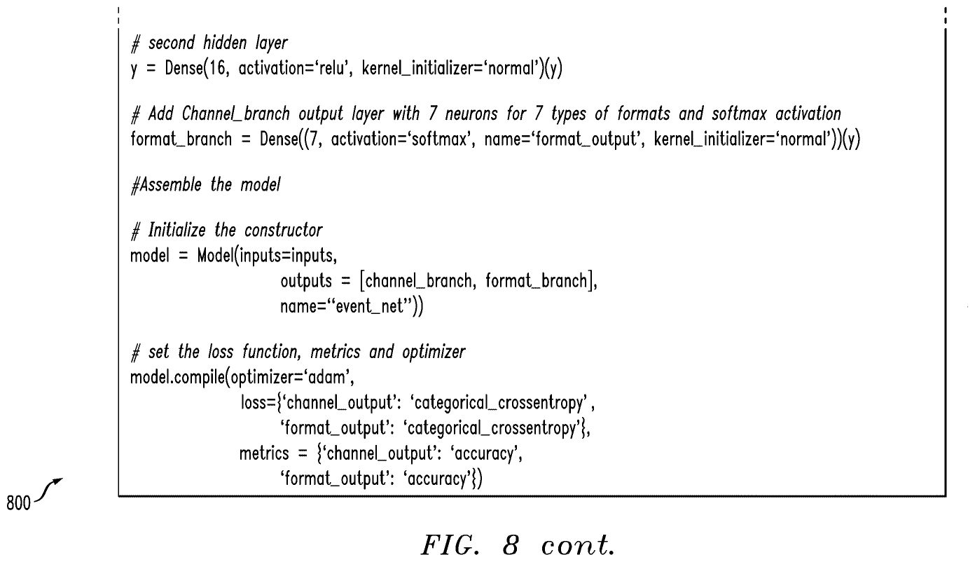

FIG. 8 shows example pseudocode for neural network model creation in an illustrative embodiment. In this embodiment, example pseudocode 800 is executed by or under the control of at least one processing system and/or device. For example, the example pseudocode 800 may be viewed as comprising a portion of a software implementation of at least part of automated event-related communication data management system 105 of the FIG. 1 embodiment.

The example pseudocode 800 illustrates creating a multi-layer, multi-output capable dense neural network using a Keras library. Using the function Model( ), the functional model is created, and then individual layers of each branch are added by calling the add( ) function of the model and passing an instance of the Dense( ) function to indicate that it is a dense neural network. That way, all of the nodes/neurons in each layer will connect with all of the nodes/neurons from preceding and following layers. This Dense( ) function will accept parameters for the number of nodes/neurons on the given layer, the type of activation function(s) used, and if there are any kernel parameters. Multiple hidden layers, as well as the output layer, can be added by calling the same add( ) function to the model. Once the model is created, a loss function, optimizer type, and validation metrics are added to the model using the compile( ) function. In one or more embodiments, categorical_crossentropy is used as the loss function, ADAM is used as the optimizer, and accuracy is used as the metric. Additionally, the same process can be used for creating both the branches of the neural network.

It is to be appreciated that this particular example pseudocode shows just one example implementation of neural network model creation, and alternative implementations of the process can be used in other embodiments.

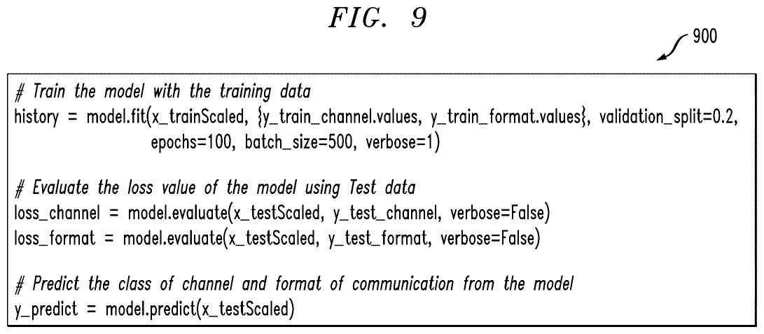

FIG. 9 shows example pseudocode for model training, validation, and execution in an illustrative embodiment. In this embodiment, example pseudocode 900 is executed by or under the control of at least one processing system and/or device. For example, the example pseudocode 900 may be viewed as comprising a portion of a software implementation of at least part of automated event-related communication data management system 105 of the FIG. 1 embodiment.

The example pseudocode 900 illustrates training the neural network model by calling the fit( ) function of the model and passing the training data and the number of epochs. After the model completes the specified number of epochs, the model is considered trained and ready for validation. As also depicted in example pseudocode 900, the loss/error value can be obtained by calling the evaluate( ) function of the model and passing testing data, wherein the loss/error value indicates how well the model is trained. A higher loss/error value indicates that the model is not yet sufficiently trained, and hyperparameter tuning may be required. For example, the number of epochs can be increased to further train the model. Additionally or alternatively, other hyperparameter tuning can be performed, for instance, by changing the loss function, changing the optimizer algorithm, and/or changing the neural network architecture (e.g., by adding one or more hidden layers).

Once the model is sufficiently trained with a reasonable value of loss (e.g., as close to zero as possible), the model is ready for use in generating predictions. Generating predictions can be achieved by calling the predict( ) function of the model and passing the independent variables of the testing data (e.g., for comparing training data and testing data) and/or the real values that need to be predicted to predict the channel(s) and the format(s) of the event-related communication (e.g., the target variable(s)). In other words, the model will be trained using historical data while the prediction (of notification channel and notification format) will be generated using actual event data after the event data are generated from the event source application(s).

It is to be appreciated that this particular example pseudocode shows just one example implementation of model training, validation, and execution, and alternative implementations of the process can be used in other embodiments.

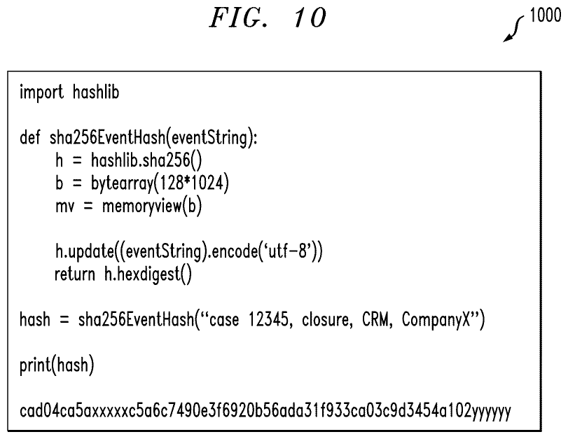

FIG. 10 shows example pseudocode for implementing at least a portion of an event notification hashing engine in an illustrative embodiment. In this embodiment, example pseudocode 1000 is executed by or under the control of at least one processing system and/or device. For example, the example pseudocode 1000 may be viewed as comprising a portion of a software implementation of at least part of automated event-related communication data management system 105 of the FIG. 1 embodiment.

The example pseudocode 1000 illustrates implementing a smart event notification hashing engine, which is responsible for maintaining the state of the communication of the event-related information. This state management facilitates eliminating the need for duplicate communication of event notifications if, for example, an enterprise process generates multiple requests for the same event. The event notification hashing engine achieves this by creating a unique identifier of the notification request by generating a hash from various attributes of the event and storing the digest in a persistent cache after the communication for the event has been completed. Upon receiving a notification request to verify a past communication of the same event, the event notification hashing engine searches the cache with the identifier of the event (hash) and returns the result of the communication, if found.

As also depicted in example pseudocode 1000, a strong hash and/or digest of a given file is created using a cryptographic function such as the SHA-256 algorithm (e.g., which can be available in python library). By reading the file in chunks, a large file can be efficiently processed for creating a digest. As also shown in example pseudocode 1000, a hash of an event string is created by concatenating at least a portion of the event's attributes. Once an event is communicated successfully the first time, the unique hash and/or digest that identifies the event notification is cached in the engine for the future search and/or reference. Also, an event notification processing workflow can include calling this component to verify if an event communication has occurred and/or been processed previously. Finding the event digest in the cache indicates that a communication has previously occurred and/or been processed, and subsequent notification requests for that event can be ignored, thus eliminating duplicate communication and improving user satisfaction and/or efficiency.

It is to be appreciated that this particular example pseudocode shows just one example implementation of an event notification hashing engine, and alternative implementations of the process can be used in other embodiments.

It is to be appreciated that a “model,” as used herein, refers to an electronic digitally stored set of executable instructions and data values, associated with one another, which are capable of receiving and responding to a programmatic or other digital call, invocation, and/or request for resolution based upon specified input values, to yield one or more output values that can serve as the basis of computer-implemented recommendations, output data displays, machine control, etc. Persons of skill in the field may find it convenient to express models using mathematical equations, but that form of expression does not confine the model(s) disclosed herein to abstract concepts; instead, each model herein has a practical application in a processing device in the form of stored executable instructions and data that implement the model using the processing device.

FIG. 11 is a flow diagram of a process for automatically managing event-related communication data using machine learning techniques in an illustrative embodiment. It is to be understood that this particular process is only an example, and additional or alternative processes can be carried out in other embodiments.

In this embodiment, the process includes steps 1100 through 1106. These steps are assumed to be performed by automated event-related communication data management system 105 utilizing elements 112, 114, 116 and 118.

Step 1100 includes obtaining event-related communication data generated in connection with one or more systems associated with at least one enterprise. Step 1102 includes comparing identifying information pertaining to one or more event notifications within the event-related communication data to identifying information pertaining to multiple historical event notifications stored in at least one database. In one or more embodiments, comparing identifying information pertaining to one or more event notifications within the event-related communication data to identifying information pertaining to multiple historical event notifications stored in at least one database includes comparing at least one hash attributed to the one or more event notifications within the event-related communication data to at least one hash attributed to each of the multiple historical event notifications stored in the at least one database.

Step 1104 includes predicting, for the one or more event notifications upon determining that the identifying information pertaining to the one or more event notifications differs from the identifying information pertaining to the multiple historical event notifications, at least one communication channel and at least one communication format by processing at least a portion of the obtained event-related communication data using one or more machine learning techniques. In at least one embodiment, processing at least a portion of the obtained event-related communication data using one or more machine learning techniques includes processing at least a portion of the obtained event-related communication data using at least one neural network comprising at least one input layer, at least one hidden layer, and at least one output layer. In such an embodiment, the at least one neural network includes a deep neural network comprising multiple parallel branches, across the at least one hidden layer and the at least one output layer, with each of the multiple parallel branches corresponding to one of multiple types of outputs. Additionally, in such an embodiment, the at least one hidden layer can include at least one activation function (e.g., at least one ReLU activation function), and the at least one output layer can include at least one activation function (e.g., at least one softmax activation function).

Also, in at least one embodiment, processing at least a portion of the obtained event-related communication data using one or more machine learning techniques can include processing a set of input data from the obtained event-related communication data, wherein the set of input data includes two or more of event source-related data, event type-related data, event status-related data, destination-related data, and language-related data. Additionally, processing at least a portion of the obtained event-related communication data using one or more machine learning techniques can include generating multiple outputs. In such an embodiment, the multiple outputs can include a first output identifying a communication channel to be used for at least one of the one or more event notifications, and a second output identifying a communication format to be used for at least one of the one or more event notifications.

Step 1106 includes performing one or more automated actions based at least in part on the at least one predicted communication channel and the at least one predicted communication format. In one or more embodiments, performing one or more automated actions includes generating and outputting at least one event notification in accordance with the at least one predicted communication channel and the at least one predicted communication format. Additionally or alternatively, performing one or more automated actions can include automatically training the one or more machine learning techniques using feedback generated in connection with one or more of the at least one predicted communication channel and the at least one predicted communication format. Also, one or more embodiments can include automatically training the one or more machine learning techniques using historical event notification data and corresponding context-related information.

In at least one embodiment, the techniques depicted in FIG. 11 can also include generating cryptographic information attributed to at least a portion of the event-related communication data by processing the at least a portion of the event-related communication data using at least one cryptographic function, wherein the identifying information pertaining to one or more event notifications within the event-related communication data includes at least a portion of the generated cryptographic information. In such an embodiment, the at least one cryptographic function includes at least one secure hash algorithm.

Accordingly, the particular processing operations and other functionality described in conjunction with the flow diagram of FIG. 11 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically manage event-related communication data using machine learning techniques. These and other embodiments can effectively overcome problems associated with redundant communications lack of context-based determinations.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

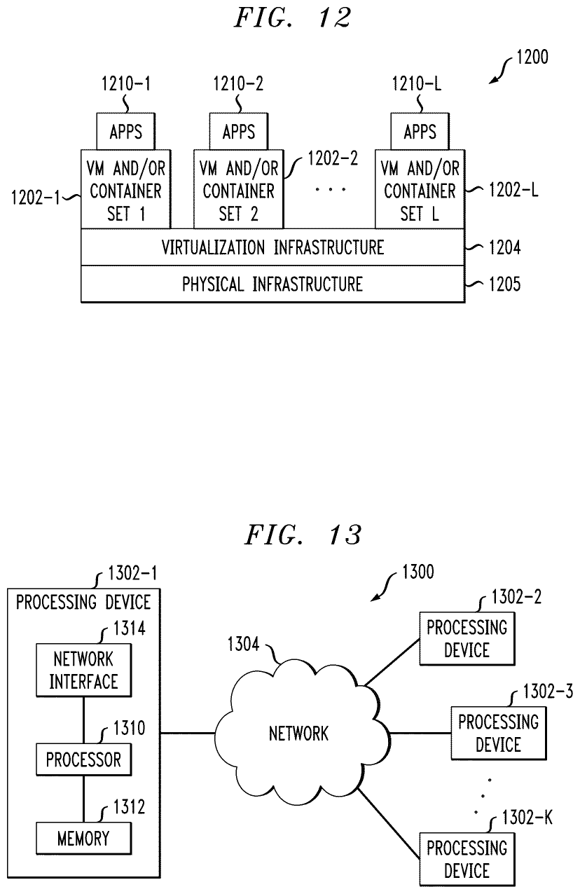

Illustrative embodiments of processing platforms will now be described in greater detail with reference to FIGS. 12 and 13. Although described in the context of system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that are utilized to implement at least a portion of the information processing system 100. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 comprise respective VMs, respective sets of one or more containers, or respective sets of one or more containers running in VMs. In some implementations of the FIG. 12 embodiment, the VMs/container sets 1202 comprise respective VMs implemented using virtualization infrastructure 1204 that comprises at least one hypervisor.

A hypervisor platform may be used to implement a hypervisor within the virtualization infrastructure 1204, wherein the hypervisor platform has an associated virtual infrastructure management system. The underlying physical machines comprise one or more information processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of system 100 and includes a plurality of processing devices, denoted 1302-1, 1302-2, 1302-3, . . . 1302-K, which communicate with one another over a network 1304.

The network 1304 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1302-1 in the processing platform 1300 comprises a processor 1310 coupled to a memory 1312.

The processor 1310 comprises a microprocessor, a CPU, a GPU, a TPU, a microcontroller, an ASIC, a FPGA or other type of processing circuitry, as well as portions or combinations of such circuitry elements.

The memory 1312 comprises random access memory (RAM), read-only memory (ROM) or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining event-related communication data generated in connection with one or more systems associated with at least one enterprise;
comparing identifying information pertaining to one or more event notifications within the event-related communication data to identifying information pertaining to multiple historical event notifications stored in at least one database;
predicting, for the one or more event notifications upon determining that the identifying information pertaining to the one or more event notifications differs from the identifying information pertaining to the multiple historical event notifications, at least one communication channel and at least one communication format by processing at least a portion of the obtained event-related communication data using one or more machine learning techniques; and
performing one or more automated actions based at least in part on the at least one predicted communication channel and the at least one predicted communication format;
wherein the method is performed by at least one processing device comprising a processor coupled to a memory.

2. The computer-implemented method of claim 1, wherein processing at least a portion of the obtained event-related communication data using one or more machine learning techniques comprises processing at least a portion of the obtained event-related communication data using at least one neural network comprising at least one input layer, at least one hidden layer, and at least one output layer.

3. The computer-implemented method of claim 2, wherein the at least one neural network comprises a deep neural network comprising multiple parallel branches, across the at least one hidden layer and the at least one output layer, with each of the multiple parallel branches corresponding to one of multiple types of outputs.

4. The computer-implemented method of claim 2, wherein the at least one hidden layer comprises at least one activation function, and wherein the at least one activation function of the at least one hidden layer comprises at least one rectified linear unit activation function.

5. The computer-implemented method of claim 2, wherein the at least one output layer comprises at least one activation function, and wherein the at least one activation function of the at least one output layer comprises at least one softmax activation function.

6. The computer-implemented method of claim 1, wherein processing at least a portion of the obtained event-related communication data using one or more machine learning techniques comprises processing a set of input data from the obtained event-related communication data, wherein the set of input data comprises two or more of event source-related data, event type-related data, event status-related data, destination-related data, and language-related data.

7. The computer-implemented method of claim 1, wherein processing at least a portion of the obtained event-related communication data using one or more machine learning techniques comprises generating multiple outputs, wherein the multiple outputs comprise a first output comprising identification of a communication channel to be used for at least one of the one or more event notifications, and a second output comprising identification of a communication format to be used for at least one of the one or more event notifications.

8. The computer-implemented method of claim 1, further comprising:
generating cryptographic information attributed to at least a portion of the event-related communication data by processing the at least a portion of the event-related communication data using at least one cryptographic function, wherein the identifying information pertaining to one or more event notifications within the event-related communication data comprises at least a portion of the generated cryptographic information.

9. The computer-implemented method of claim 8, wherein the at least one cryptographic function comprises at least one secure hash algorithm.

10. The computer-implemented method of claim 1, wherein comparing identifying information pertaining to one or more event notifications within the event-related communication data to identifying information pertaining to multiple historical event notifications stored in at least one database comprises comparing at least one hash attributed to the one or more event notifications within the event-related communication data to at least one hash attributed to each of the multiple historical event notifications stored in the at least one database.

11. The computer-implemented method of claim 1, wherein performing one or more automated actions comprises generating and outputting at least one event notification in accordance with the at least one predicted communication channel and the at least one predicted communication format.

12. The computer-implemented method of claim 1, wherein performing one or more automated actions comprises automatically training the one or more machine learning techniques using feedback generated in connection with one or more of the at least one predicted communication channel and the at least one predicted communication format.

13. The computer-implemented method of claim 1, further comprising:
automatically training the one or more machine learning techniques using historical event notification data and corresponding context-related information.

14. A non-transitory processor-readable storage medium having stored therein program code of one or more software programs, wherein the program code when executed by at least one processing device causes the at least one processing device:
to obtain event-related communication data generated in connection with one or more systems associated with at least one enterprise;
to compare identifying information pertaining to one or more event notifications within the event-related communication data to identifying information pertaining to multiple historical event notifications stored in at least one database;
to predict, for the one or more event notifications upon determining that the identifying information pertaining to the one or more event notifications differs from the identifying information pertaining to the multiple historical event notifications, at least one communication channel and at least one communication format by processing at least a portion of the obtained event-related communication data using one or more machine learning techniques; and
to perform one or more automated actions based at least in part on the at least one predicted communication channel and the at least one predicted communication format.

15. The non-transitory processor-readable storage medium of claim 14, wherein processing at least a portion of the obtained event-related communication data using one or more machine learning techniques comprises processing at least a portion of the obtained event-related communication data using at least one neural network comprising at least one input layer, at least one hidden layer, and at least one output layer.

16. The non-transitory processor-readable storage medium of claim 15, wherein the at least one neural network comprises a deep neural network comprising multiple parallel branches, across the at least one hidden layer and the at least one output layer, with each of the multiple parallel branches corresponding to one of multiple types of outputs.

17. The non-transitory processor-readable storage medium of claim 14, wherein the program code when executed by the at least one processing device causes the at least one processing device:
to generate cryptographic information attributed to at least a portion of the event-related communication data by processing the at least a portion of the event-related communication data using at least one cryptographic function, wherein the identifying information pertaining to one or more event notifications within the event-related communication data comprises at least a portion of the generated cryptographic information.

18. An apparatus comprising:
at least one processing device comprising a processor coupled to a memory;
the at least one processing device being configured:
to obtain event-related communication data generated in connection with one or more systems associated with at least one enterprise;
to compare identifying information pertaining to one or more event notifications within the event-related communication data to identifying information pertaining to multiple historical event notifications stored in at least one database;
to predict, for the one or more event notifications upon determining that the identifying information pertaining to the one or more event notifications differs from the identifying information pertaining to the multiple historical event notifications, at least one communication channel and at least one communication format by processing at least a portion of the obtained event-related communication data using one or more machine learning techniques; and
to perform one or more automated actions based at least in part on the at least one predicted communication channel and the at least one predicted communication format.

19. The apparatus of claim 18, wherein processing at least a portion of the obtained event-related communication data using one or more machine learning techniques comprises processing at least a portion of the obtained event-related communication data using at least one neural network comprising at least one input layer, at least one hidden layer, and at least one output layer.

20. The apparatus of claim 19, wherein the at least one neural network comprises a deep neural network comprising multiple parallel branches, across the at least one hidden layer and the at least one output layer, with each of the multiple parallel branches corresponding to one of multiple types of outputs.
